(19) United States
(12) Patent Application Publication
(10) Pub. No.: US 2016/0224140 A1
(43) Pub. Date: Aug. 4, 2016

(54) TRANSPARENT CONDUCTIVE FILM

(71) Applicant: NITTO DENKO CORPORATION, Osaka (JP)

(72) Inventors: Shoichi Matsuda, Ibaraki-shi (JP); Kazumasa Okada, Ibaraki-shi (JP); Hiroshi Tomohisa, Ibaraki-shi (JP); Ayami Nakato, Ibaraki-shi (JP); Kazuto Yamagata, Ibaraki-shi (JP)

(73) Assignee: NITTO DENKO CORPORATION, Ibaraki-shi, Osaka (JP)

(21) Appl. No.: 14/916,087

(22) PCT Filed: Sep. 1, 2014
(86) PCT No.: PCT/JP2014/072896

§ 371 Date: Mar. 2, 2016

(30) Foreign Application Priority Data
Sep. 3, 2013 (JP) 2013-181984

(51) Int. Cl. G06F 3/041; B32B 27/06

(52) U.S. Cl. CPC G06F 3/041; B32B 27/06; G06F 2203/04102; G06F 2203/04103; B32B 2307/202; B32B 2307/412; B32B 2307/418; B32B 2457/20; B32B 2262/103

(57) ABSTRACT

Provided is a transparent conductive film suppressed in light scattering while containing a conductive filler. The transparent conductive film of the present invention includes, in this order: a resin layer; an intermediate layer; and a transparent base material, in which: the transparent conductive film contains a conductive filler present in the resin layer; the transparent base material has an average refractive index of less than 1.6; and when light is caused to enter the transparent conductive film from a resin layer side, an electric field intensity of the light in the resin layer is less than 100% relative to an electric field intensity of the light in the transparent base material.

### TECHNICAL FIELD

The present invention relates to a transparent conductive film.

### BACKGROUND ART

A film having a metal oxide layer serving as a conductive layer has heretofore been used as a transparent conductive film to be used in, for example, an electrode of a touch sensor. However, the transparent conductive film including the metal oxide layer involves a problem in that it is difficult to use the film in applications where flexibility is required, such as a flexible display, because the conductivity of the film is liable to be lost owing to a crack caused by its bending.

Meanwhile, a transparent conductive film having formed therein a conductive region including a metal nanowire has been known as the transparent conductive film. The transparent conductive film can have high flexibility. However, the transparent conductive film involves a problem in that incident light is scattered by the metal nanowire. When such transparent conductive film is used in an image display apparatus, the following problem occurs. The pattern of the conductive region (conductive pattern) is visually observed.

### CITATION LIST

### Patent Literature

[PTL 1] JP 2009-505358 A

### SUMMARY OF INVENTION

### Technical Problem

The present invention has been made to solve the problems, and an object of the present invention is to provide a transparent conductive film suppressed in light scattering while containing a conductive filler.

### Solution to Problem

According to one embodiment of the present invention, there is provided a transparent conductive film, including, in this order: a resin layer; an intermediate layer; and a transparent base material, in which: the transparent conductive film contains a conductive filler present in the resin layer; the transparent base material has an average refractive index of less than 1.6; and when light is caused to enter the transparent conductive film from a resin layer side, an electric field intensity of the light in the resin layer is less than 100% relative to an electric field intensity of the light in the transparent base material.

In one embodiment, the intermediate layer has an average refractive index of 1.5 or more, and the intermediate layer has a thickness of 200 nm or less.

In one embodiment, an average refractive index of the resin layer is lower than an average refractive index of the intermediate layer.

In one embodiment, the conductive filler includes a metal nanowire.

In one embodiment, the metal nanowire includes a silver nanowire.

According to another embodiment of the present invention, there is provided a touch sensor. The touch sensor includes the transparent conductive film.

### Advantageous Effects of Invention

According to the embodiment of the present invention, the transparent conductive film suppressed in light scattering while containing a conductive filler (e.g., a metal nanowire) can be provided. Such transparent conductive film can be suitably used in, for example, a display apparatus required to have flexibility, and can reduce adverse effects on the display characteristics of the display apparatus. Further, in the present invention, when a conductive pattern is formed on the transparent conductive film by distinguishing a region where the conductive filler is present and a region where the conductive filler is not present from each other, the conductive pattern can be prevented from being viewed.

More specifically, the transparent conductive film according to the embodiment of the present invention includes a resin layer and a conductive filler present in the resin layer, and light whose electric field intensity has been appropriately adjusted can be transmitted through the resin layer, and hence light scattering by the conductive filler present in the resin layer can be suppressed. In addition, the light scattering is suppressed as described above, and hence upon formation of a conductive pattern as described above, a difference in haze value between a region where the conductive filler is present (conductive region) and a region where the conductive filler is not present (insulating region) reduces. Accordingly, a transparent conductive film whose conductive pattern is hardly viewed can be obtained.

### BRIEF DESCRIPTION OF DRAWINGS

FIG. 1 is a schematic sectional view of a transparent conductive film according to one embodiment of the present invention.

FIG. 2 is a schematic sectional view of a transparent conductive film according to another embodiment of the present invention.

FIG. 3 is a schematic sectional view of a transparent conductive film according to still another embodiment of the present invention.

### DESCRIPTION OF EMBODIMENTS

A. Entire Construction of Transparent Conductive Film

FIG. 1 is a schematic sectional view of a transparent conductive film according to one embodiment of the present invention. A transparent conductive film 100 includes a resin layer 10, an intermediate layer 20, and a transparent base material 30 in this order. The conductive film 100 contains a conductive filler 1, and the conductive filler 1 is present in the resin layer 10. In one embodiment, the conductive filler (e.g., a metal nanowire) is present so that part of the conductive filler (e.g., a portion having a length of from 0.1 μm to 1 μm) may protrude from the resin layer. When part of the conductive filler protrudes, a transparent conductive film that can be suitably used as an electrode can be provided. The average refractive index of the transparent base material 30 is less than 1.6.

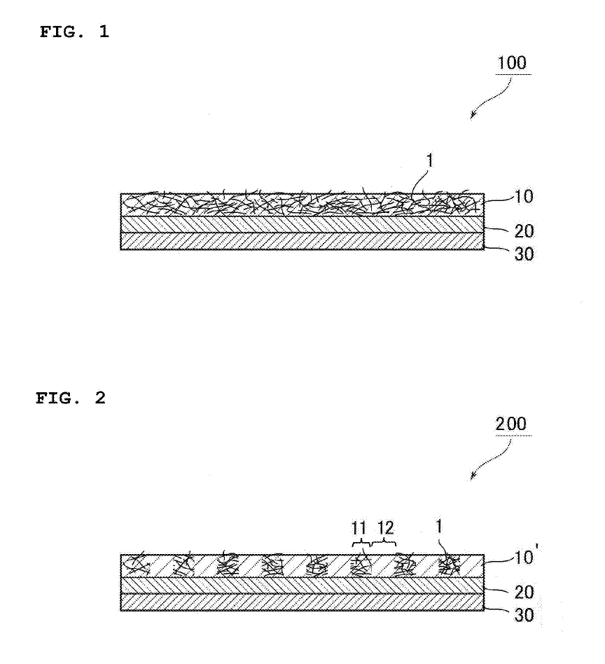

The conductive filler 1 may be present over the entirety of the resin layer 10 as illustrated in FIG. 1, or may be unevenly distributed in a resin layer 10′ as illustrated in FIG. 2. In an embodiment illustrated in FIG. 2, the resin layer 10′ includes a region where the conductive filler 1 is present (a conductive region 11) and a region where the conductive filler is not present (an insulating region 12). The conductive region 11 is formed in any appropriate pattern in plan view. The pattern of the conductive region 11 is hereinafter sometimes referred to as “conductive pattern.” The insulating region 12 is a region except the conductive region 11 in the resin layer 10′. The insulating region 12 can be formed by, for example, subjecting the conductive film in a state illustrated in FIG. 1 to any appropriate etching treatment.

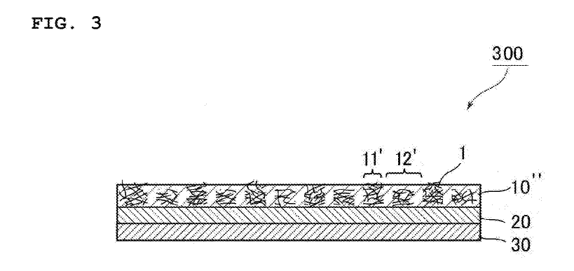

FIG. 3 is a schematic sectional view of a transparent conductive film according to still another embodiment of the present invention. In a transparent conductive film 300 of FIG. 3, the conductive filler 1 is present over the entirety of a resin layer 10″, and the resin layer 10″ includes a conductive region 11′ and an insulating region 12′. In this embodiment, the conductive region 11′ can conduct electricity by virtue of the contribution of the conductive filler 1. Meanwhile, when the conductive filler 1 is broken, the insulating region 12′ serving as a region insulated from the conductive region 11′ is formed. It should be noted that in FIG. 3, in order to facilitate understanding, an interval between the conductive fillers 1 of broken portions is illustrated on an enlarged scale, but the interval between the conductive fillers 1 of the broken portions is not particularly limited as long as the conductive fillers 1 are not in contact with each other at a boundary between the conductive region 11′ and the insulating region 12′.

In the transparent conductive film of the present invention, the electric field intensity of light entering the transparent conductive film in the resin layer is smaller than its electric field intensity in the transparent base material, and hence the scattering of the light by the conductive filler is suppressed. When light is caused to enter the transparent conductive film of the present invention from a resin layer side, the electric field intensity of the light in the resin layer is less than 100%, preferably 98% or less, more preferably from 80% to 95% relative to the electric field intensity of the light in the transparent base material. It should be noted that the term “electric field intensity” as used herein refers to the peak value of an amplitude when the electric field of the light is represented by a wave equation. In addition, the expression “electric field intensity of the light in the resin layer” means an electric field intensity in the resin layer excluding an influence of the conductive filler, in other words, the electric field intensity of the light in the resin layer in a film in which it is assumed that the conductive filler is not present (film including the resin layer, the intermediate layer, and the transparent base material).

The conductive film of the present invention has such a configuration that the resin layer can transmit light whose electric field intensity falls within the range, and the scattering of the light by the conductive filler can be suppressed by forming the conductive region through the introduction of the conductive filler into the resin layer. Suppressing the scattering of the light by the conductive filler suppresses an increase in haze value of the conductive region. Such conductive film can be suitably used in a display apparatus (as, for example, an electrode). In addition, when the conductive pattern is formed by distinguishing the region where the conductive filler is present (conductive region) and the region where the conductive filler is not present (insulating region) from each other, a difference in haze value between the conductive region and the insulating region can be reduced, and hence a transparent conductive film whose conductive pattern is hardly viewed can be obtained. The electric field intensity of the light in the resin layer may vary in accordance with, for example, materials forming the resin layer, the intermediate layer, and the transparent base material, and a combination of the materials forming the respective layers. The electric field intensity of the light in the resin layer can be adjusted by, for example, combining the resin layer and any other appropriate member (layer) to form the transparent conductive film. The magnitude of the electric field intensity of the light in the insulating region of the resin layer can be adjusted by, for example, arranging the resin layer, the intermediate layer, and the transparent base material in this order as described above, and appropriately setting the average refractive indices of the transparent base material and the intermediate layer.

A difference between the average refractive index of the intermediate layer and the average refractive index of the transparent base material (average refractive index of the intermediate layer−average refractive index of the transparent base material) is preferably 0.1 or more, more preferably 0.2 or more, still more preferably from 0.2 to 1, particularly preferably from 0.2 to 0.5. When the difference falls within such range, the electric field intensity of the light in the resin layer, more specifically the ratio of the electric field intensity of the light in the resin layer to the electric field intensity of the light in the transparent base material can be appropriately adjusted. It should be noted that the average refractive index as used herein refers to an average refractive index at 23° C. and a wavelength of 550 nm. In addition, the average refractive index refers to the average of a refractive index nx in the direction in which an in-plane refractive index becomes maximum (i.e., a slow axis direction), a refractive index ny in the direction perpendicular to the slow axis in a plane (i.e., a fast axis direction), and a thickness direction refractive index nz.

In one embodiment, the average refractive index of the resin layer is lower than the average refractive index of the intermediate layer. A difference between the average refractive index of the intermediate layer and the average refractive index of the resin layer is preferably 0.1 or more, more preferably 0.2 or more, still more preferably from 0.2 to 1, particularly preferably from 0.2 to 0.5. When the difference falls within such range, the electric field intensity of the light in the resin layer, more specifically the ratio of the electric field intensity of the light in the resin layer to the electric field intensity of the light in the transparent base material can be appropriately adjusted.

The total light transmittance of the transparent conductive film of the present invention is preferably 80% or more, more preferably 85% or more, particularly preferably 90% or more. In the present invention, conductivity is expressed by the conductive filler, and hence a transparent conductive film having a high total light transmittance can be obtained. It should be noted that the expression “total light transmittance of the transparent conductive film” means a total light transmittance measured for the entirety of the transparent conductive film, and also in the case where the conductive region and the insulating region are formed, means a total light transmittance measured while both of these regions are included.

The surface resistance value of the transparent conductive film of the present invention is preferably from 0.1Ω/□ to 1,000Ω/□, more preferably from 0.5Ω/□ to 500Ω/□, particularly preferably from 1Ω/□ to 250Ω/□. In the present invention, a transparent conductive film having a small surface resistance value can be obtained by virtue of including the conductive filler. In addition, with a small amount of the conductive filler, the surface resistance value can be reduced as described above and hence excellent conductivity can be expressed. Accordingly, a transparent conductive film having a highlight transmittance can be obtained.

B. Resin Layer

The resin layer is a layer having light transparency (e.g., light transparency corresponding to a total light transmittance of 85% or more). The resin layer can function as a conductor in combination with the conductive filler present in the resin layer. In one embodiment, as described above, the resin layer includes the conductive region and the insulating region.

The average refractive index of the resin layer is preferably from 1.1 to 2.0, more preferably from 1.2 to 1.8.

The thickness of the resin layer is preferably from 10 nm to 10,000 nm, more preferably from 50 nm to 3,000 nm, particularly preferably from 100 nm to 1,000 nm. When the thickness falls within such range, a transparent conductive film excellent in conductivity and light transparency can be obtained.

When the resin layer includes the region where the conductive filler is present (conductive region) and the region where the conductive filler is not present (insulating region), the absolute value of a difference between the haze value of the resin layer in the conductive region and the haze value of the resin layer in the insulating region is preferably 0.35% or less, more preferably 0.3% or less. When the absolute value falls within such range, a transparent conductive film whose conductive pattern is hardly viewed can be obtained.

The haze value of the resin layer in the region where the conductive filler is present is preferably 5% or less, more preferably 2% or less, particularly preferably 1.5% or less. The haze value of the resin layer in the insulating region where the conductive filler is not present is preferably 5% or less, more preferably 2% or less, still more preferably 1.5% or less, particularly preferably 1% or less.

Any appropriate resin may be used as a material constituting the resin layer. Examples of the resin include: an acrylic resin; a polyester-based resin, such as polyethylene terephthalate; an aromatic resin, such as polystyrene, polyvinyltoluene, polyvinylxylene, polyimide, polyamide, or polyamide imide; a polyurethane-based resin; an epoxy-based resin; a polyolefin-based resin; an acrylonitrile-butadiene-styrene copolymer (ABS); cellulose; a silicon-based resin; polyvinyl chloride; polyacetate; polynorbornene; a synthetic rubber; and a fluorine-based resin. Of those, a curable resin (preferably a UV-curable resin) constituted of a polyfunctional acrylate, such as pentaerythritol triacrylate (PETA), neopentyl glycol diacrylate (NPGDA), dipentaerythritol hexaacrylate (DPHA), dipentaerythritol pentaacrylate (DPPA), or trimethylolpropane triacrylate (TMPTA), is preferably used. It should be noted that in one embodiment, the resin layer alone does not have conductivity and a nonconductive resin is used as a material constituting the resin layer.

C. Conductive Filler

Examples of the conductive filler include a metal nanowire, a metal whisker, and a metal particle. Of those, a metal nanowire is preferred.

The metal nanowire refers to a conductive substance that is made of a metal material, has a thread-like shape, and has a diameter of the order of nanometers. The metal nanowire may be linear or may be curved. When an electrical conduction path is formed of the conductive region including the metal nanowire, a transparent conductive film excellent in bending resistance can be obtained. In addition, the metal nanowire can be present so as to be dispersed in the resin layer, and hence a transparent conductive film in which an electric resistance is reduced, a light transmission path is sufficiently secured, and a light transmittance is high can be obtained.

A ratio (aspect ratio: L/d) between a thickness d and a length L of the metal nanowire is preferably from 10 to 100,000, more preferably from 50 to 100,000, particularly preferably from 100 to 10,000. When a metal nanowire having such large aspect ratio as described above is used, the metal nanowire satisfactorily intersects with itself and hence high conductivity can be expressed with a small amount of the metal nanowire. As a result, a transparent conductive film having a high light transmittance can be obtained. It should be noted that the term “thickness of the metal nanowire” as used herein has the following meanings: when a section of the metal nanowire has a circular shape, the term means the diameter of the circle; when the section has an elliptical shape, the term means the short diameter of the ellipse; and when the section has a polygonal shape, the term means the longest diagonal of the polygon. The thickness and length of the metal nanowire can be observed with a scanning electron microscope or a transmission electron microscope.

The thickness of the metal nanowire is preferably less than 500 nm, more preferably less than 200 nm, particularly preferably from 10 nm to 100 nm, most preferably from 10 nm to 50 nm. When the thickness falls within such range, a conductive film having a high light transmittance can be formed.

The length of the metal nanowire is preferably from 2.5 μm to 1,000 μm, more preferably from 10 μm to 500 μm, particularly preferably from 20 μm to 100 μm. When the length falls within such range, a transparent conductive film having high conductivity can be obtained.

Any appropriate metal may be used as a metal constituting the metal nanowire as long as the metal has high conductivity. The metal nanowire preferably contains one or more kinds of metals selected from the group consisting of gold, platinum, silver, and copper. Of those, silver, copper, or gold is preferred from the viewpoint of conductivity, and silver is more preferred. In addition, a material obtained by subjecting the metal to metal plating (e.g., gold plating) may be used.

The content of the metal nanowire in the conductive region is preferably from 30 wt % to 96 wt %, more preferably from 43 wt % to 88 wt % with respect to the total weight of the conductive region. When the content falls within such range, a transparent conductive film excellent in conductivity and light transparency can be obtained.

When the metal nanowire is a silver nanowire, the density of the conductive region is preferably from 1.3 g/cm³ to 7.4 g/cm³, more preferably from 1.6 g/cm³ to 4.8 g/cm³. When the density falls within such range, a transparent conductive film excellent in conductivity and light transparency can be obtained.

Any appropriate method may be adopted as a method of producing the metal nanowire. Examples thereof include: a method involving reducing silver nitrate in a solution; and a method involving causing an applied voltage or current to act on a precursor surface from the tip portion of a probe, drawing a metal nanowire at the tip portion of the probe, and continuously forming the metal nanowire. In the method involving reducing silver nitrate in the solution, a silver nanowire can be synthesized by performing the liquid-phase reduction of a silver salt, such as silver nitrate, in the presence of a polyol, such as ethylene glycol, and polyvinyl pyrrolidone. The mass production of a silver nanowire having a uniform size can be performed in conformity with a method described in, for example, Xia, Y. et al., Chem. Mater. (2002), 14, 4736-4745 or Xia, Y. et al., Nano letters (2003), 3 (7), 955-960.

D. Intermediate Layer

The arrangement of the intermediate layer can control the reflection characteristics/reflection characteristic of the transparent base material and/or the resin layer. Specifically, the arrangement of an intermediate layer having an average refractive index higher than the average refractive index of the transparent base material can control a reflection characteristic at an interface between the transparent base material and the intermediate layer, and/or a reflection characteristic at an interface between the resin layer and the intermediate layer, and hence light whose electric field intensity has been adjusted can be transmitted through the resin layer as described above.

The average refractive index of the intermediate layer is preferably 1.5 or more, more preferably 1.7 or more, still more preferably from 1.7 to 2.0. When the average refractive index falls within such range, the electric field intensity of light in the resin layer can be appropriately adjusted. As a result, a transparent conductive film suppressed in light scattering by its conductive filler can be obtained.

The intermediate layer may include an organic material, may include an inorganic material, or may include a mixed material of organic matter and inorganic matter.

Examples of the organic material constituting the intermediate layer include a (meth)acrylic resin, a urethane-based resin, a melamine-based resin, an alkyd-based resin, and a siloxane-based resin. Of those, a (meth)acrylic resin is preferably used. This is because an intermediate layer having a high average refractive index can be formed.

Examples of the inorganic material constituting the intermediate layer include NaF, Na₃AlF₆, LiF, MgF₂, CaF₂, SiO₂, LaF₃, CeF₃, Al₂O₃, TiO₂, Ta₂O₅, ZrO₂, ZnO, and ZnS. Of those, ZrO₂ is preferably used. This is because an intermediate layer having a high average refractive index can be formed.

The intermediate layer can further contain nano fine particles. The incorporation of the nano fine particles can increase the average refractive index of the intermediate layer. The particle diameter (weight-average particle diameter) of the nano fine particles is preferably from 1 nm to 500 nm, more preferably from 5 nm to 300 nm. For example, ZrO₂ can be used as the nano fine particles. The content of the nano fine particles is preferably from 10 wt % to 90 wt %, more preferably from 20 wt % to 85 wt % with respect to the weight of the intermediate layer.

The thickness of the intermediate layer is preferably 200 nm or less, more preferably 100 nm or less, still more preferably from 5 nm to 100 nm, particularly preferably from 10 nm to 80 nm, most preferably from 15 nm to 50 nm. When the thickness falls within such range, as described above, light whose electric field intensity has been adjusted can be transmitted through the resin layer. As a result, a transparent conductive film suppressed in light scattering by its conductive filler can be obtained.

The total light transmittance of the intermediate layer is preferably 50% or more, more preferably 85% or more, still more preferably 90% or more.

E. Transparent Base Material

The average refractive index of the transparent base material is preferably less than 1.6, more preferably 1.59 or less, still more preferably from 1.4 to 1.55. When the average refractive index falls within such range, the electric field intensity of light in the resin layer can be appropriately adjusted.

The total light transmittance of the transparent base material is preferably 80% or more, more preferably 85% or more, still more preferably 90% or more.

Any appropriate polymer material is used as a material constituting the transparent base material as long as the average refractive index of the transparent base material can be set to less than 1.6. Such polymer material is, for example, a polymer film containing a resin, such as a cycloolefin-based resin, e.g., polynorbornene, an acrylic resin, or a polycarbonate-based resin. In one embodiment, a low-retardation transparent base material formed from such polymer film is used, and in another embodiment, a λ/4 plate formed from a stretched film of such polymer film can be used as the transparent base material.

E-1. Low-Retardation Transparent Base Material

In one embodiment, a transparent base material having a small retardation value (low-retardation transparent base material) is used as the transparent base material. An in-plane retardation Re of the low-retardation transparent base material is from 1 nm to 100 nm, preferably from 1 nm to 50 nm, more preferably from 1 nm to 10 nm, still more preferably from 1 nm to 5 nm, particularly preferably from 1 nm to 3 nm. It should be noted that the term “in-plane retardation Re” as used herein refers to an in-plane retardation value of a transparent base material at 23° C. and a wavelength of 550 nm. The Re is determined from the equation “Re=(nx−ny)×d” where nx represents a refractive index in a direction in which an in-plane refractive index becomes maximum (i.e., a slow axis direction), ny represents a refractive index in a direction perpendicular to a slow axis in a plane (i.e., a fast axis direction), and d (nm) represents the thickness of an optical film.

The absolute value of a thickness direction retardation Rth of the low-retardation transparent base material is 100 nm or less, preferably 75 nm or less, more preferably 50 nm or less, particularly preferably 10 nm or less, most preferably 5 nm or less. It should be noted that the term “thickness direction retardation Rth” as used herein refers to a thickness direction retardation value at 23° C. and a wavelength of 550 nm. The Rth is determined from the equation “Rth=(nx−nz)×d” where nx represents the refractive index in the direction in which the in-plane refractive index becomes maximum (i.e., the slow axis direction), nz represents a thickness direction refractive index, and d (nm) represents the thickness of the transparent base material.

The thickness of the low-retardation transparent base material is preferably from 500 nm to 1,000 μm, more preferably from 1 μm to 1,000 μm, still more preferably from 10 μm to 500 μm, particularly preferably from 20 μm to 150 μm. When the thickness falls within such range, a transparent base material having a small retardation can be obtained. In addition, when the thickness of the low-retardation transparent base material is 1 μm or more, a transparent conductive film excellent in mechanical characteristics can be obtained.

Any appropriate material may be used as a material constituting the low-retardation transparent base material. Specifically, for example, a polymer base material, such as a film or a plastic base material, is preferably used. This is because the smoothness of the transparent base material and its wettability to a coating liquid for forming an intermediate layer (described later) become excellent, and its productivity can be significantly improved by continuous production with a roll.

The material constituting the low-retardation transparent base material is typically a polymer film containing a thermoplastic resin as a main component. Examples of the thermoplastic resin include: a cycloolefin-based resin, such as polynorbornene; an acrylic resin; and a low-retardation polycarbonate resin. Of those, a cycloolefin-based resin or an acrylic resin is preferred, and polynorbornene or an acrylic resin having a ring structure (preferably a non-aromatic ring structure) is more preferred. The use of such resin can provide a transparent base material having a small retardation. In addition, such resin is excellent in, for example, transparency, mechanical strength, thermal stability, and moisture barrier property. The thermoplastic resins may be used alone or in combination.

The polynorbornene refers to a (co)polymer obtained by using a norbornene-based monomer having a norbornene ring as part or all of its starting materials (monomers). Examples of the norbornene-based monomer include: norbornene, alkyl- and/or alkylidene-substituted products thereof, such as 5-methyl-2-norbornene, 5-dimethyl-2-norbornene, 5-ethyl-2-norbornene, 5-butyl-2-norbornene, and 5-ethylidene-2-norbornene, and polar group- (such as halogen-) substituted products thereof; dicyclopentadiene and 2,3-dihydrodicyclopentadiene; dimethanooctahydronaphthalene, alkyl- and/or alkylidene-substituted products thereof, and polar group- (such as halogen-) substituted products thereof; and a trimer and a tetramer of cyclopentadiene, such as 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene.

Various products are commercially available as the polynorbornene. Specific examples thereof include products available under the trade names “ZEONEX” and “ZEONOR” from Zeon Corporation, a product available under the trade name “Arton” from JSR Corporation, a product available under the trade name “TOPAS” from TICONA, and a product available under the trade name “APEL” from Mitsui Chemicals, Inc.

The acrylic resin refers to a resin having a repeating unit derived from a (meth)acrylate ((meth)acrylate unit) and/or a repeating unit derived from (meth)acrylic acid ((meth)acrylic acid unit). The acrylic resin may have a constituent unit derived from a derivative of a (meth)acrylate or (meth)acrylic acid.

In the acrylic resin, the total content of the (meth)acrylate unit, the (meth)acrylic acid unit, and the constituent unit derived from a derivative of a (meth)acrylate or (meth)acrylic acid is preferably 50 wt % or more, more preferably from 60 wt % to 100 wt %, particularly preferably from 70 wt % to 90 wt % with respect to all constituent units constituting the acrylic resin. When the total content falls within such range, a transparent base material having a low retardation can be obtained.

The acrylic resin may have a ring structure on its main chain. In addition, the glass transition temperature of the acrylic resin can be increased while an increase in its retardation is suppressed. Examples of the ring structure include a lactone ring structure, a glutaric anhydride structure, a glutarimide structure, an N-substituted maleimide structure, and a maleic anhydride structure.

The lactone ring structure can adopt any appropriate structure. The lactone ring structure is preferably a four- to eight-membered ring, more preferably a five-membered ring or a six-membered ring, still more preferably a six-membered ring. A six-membered lactone ring structure is, for example, a lactone ring structure represented by the following general formula (1).

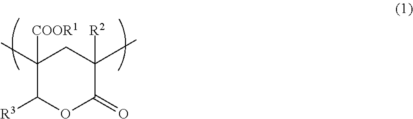

In the general formula (1), R¹, R², and R³ each independently represent a hydrogen atom, a linear or branched alkyl group having 1 to 20 carbon atoms, an unsaturated aliphatic hydrocarbon group having 1 to 20 carbon atoms, or an aromatic hydrocarbon group having 1 to 20 carbon atoms. The alkyl group, the unsaturated aliphatic hydrocarbon group, and the aromatic hydrocarbon group may each have a substituent such as a hydroxyl group, a carboxyl group, an ether group, or an ester group.

The glutaric anhydride structure is, for example, a glutaric anhydride structure represented by the following general formula (2). The glutaric anhydride structure can be obtained by, for example, subjecting a copolymer of a (meth)acrylate and (meth)acrylic acid to intramolecular dealcoholization cyclization condensation.

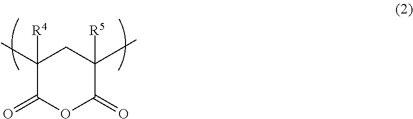

In the general formula (2), R⁴ and R⁵ each independently represent a hydrogen atom or a methyl group.

The glutarimide structure is, for example, a glutarimide structure represented by the following general formula (3). The glutarimide structure can be obtained by, for example, imidizing a (meth)acrylate polymer with an imidizing agent, such as methylamine.

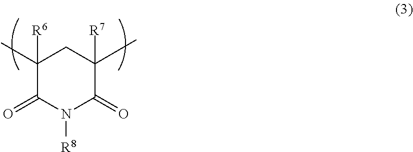

In the general formula (3), R⁶ and R⁷ each independently represent a hydrogen atom, or a linear or branched alkyl group having 1 to 8 carbon atoms, preferably a hydrogen atom or a methyl group. R⁸ represents a hydrogen atom, a linear alkyl group having 1 to 18 carbon atoms, a cycloalkyl group having 3 to 12 carbon atoms, or an aryl group having 6 to 10 carbon atoms, preferably a linear alkyl group having 1 to 6 carbon atoms, a cyclopentyl group, a cyclohexyl group, or a phenyl group.

In one embodiment, the acrylic resin has a glutarimide structure represented by the following general formula (4) and a methyl methacrylate unit.

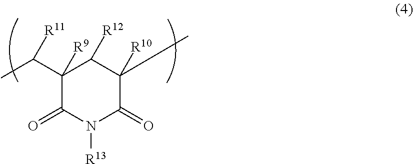

In the general formula (4), R⁹ to R¹² each independently represent a hydrogen atom, or a linear or branched alkyl group having 1 to 8 carbon atoms. R¹³ represents a linear or branched alkyl group having 1 to 18 carbon atoms, a cycloalkyl group having 3 to 12 carbon atoms, or an aryl group having 6 to 10 carbon atoms.

The N-substituted maleimide structure is, for example, an N-substituted maleimide structure represented by the following general formula (5). An acrylic resin having the N-substituted maleimide structure on its main chain can be obtained by, for example, copolymerizing an N-substituted maleimide and a (meth)acrylate.

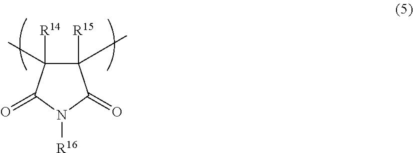

In the general formula (5), R¹⁴ and R¹⁵ each independently represent a hydrogen atom or a methyl group, and R¹⁶ represents a hydrogen atom, a linear alkyl group having 1 to 6 carbon atoms, a cyclopentyl group, a cyclohexyl group, or a phenyl group.

The maleic anhydride structure is, for example, a maleic anhydride structure represented by the following general formula (6). An acrylic resin having the maleic anhydride structure on its main chain can be obtained by, for example, copolymerizing maleic anhydride and a (meth)acrylate.

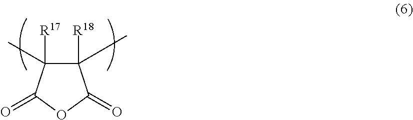

In the general formula (6), R¹⁷ and R¹⁸ each independently represent a hydrogen atom or a methyl group.

The acrylic resin may have any other constituent unit. Examples of the other constituent unit include constituent units derived from monomers, such as styrene, vinyltoluene, α-methylstyrene, acrylonitrile, methyl vinyl ketone, ethylene, propylene, vinyl acetate, methallyl alcohol, allyl alcohol, 2-hydroxymethyl-1-butene, α-hydroxymethylstyrene, α-hydroxyethylstyrene, a 2-(hydroxyalkyl)acrylate, such as methyl 2-(hydroxyethyl)acrylate, and a 2-(hydroxyalkyl)acrylic acid, such as 2-(hydroxyethyl)acrylic acid.

In addition to the acrylic resins exemplified above, specific examples of the acrylic resin also include acrylic resins disclosed in JP 2004-168882 A, JP 2007-261265 A, JP 2007-262399 A, JP 2007-297615 A, JP 2009-039935 A, JP 2009-052021 A, and JP 2010-284840 A.

The glass transition temperature of the material constituting the low-retardation transparent base material is preferably from 100° C. to 200° C., more preferably from 110° C. to 180° C., particularly preferably from 110° C. to 160° C. When the glass transition temperature falls within such range, a transparent conductive film excellent in heat resistance can be obtained.

The low-retardation transparent base material may further contain any appropriate additive as required. Specific examples of the additive include a plasticizer, a heat stabilizer, a light stabilizer, a lubricant, an antioxidant, a UV absorber, a flame retardant, a coloring agent, an antistatic agent, a compatibilizer, a cross-linking agent, and a thickener. The kind and amount of the additive to be used may be appropriately set depending on purposes.

Any appropriate molding method is employed as a method of obtaining the low-retardation transparent base material, and a proper method can be appropriately selected from, for example, a compression molding method, a transfer molding method, an injection molding method, an extrusion molding method, a blow molding method, a powder molding method, a FRP molding method, and a solvent casting method. Of those production methods, an extrusion molding method or a solvent casting method is preferably employed. This is because the smoothness of the transparent base material to be obtained is improved and hence good optical uniformity can be obtained. Molding conditions can be appropriately set depending on, for example, the composition and kind of the resin to be used.

The low-retardation transparent base material may be subjected to various surface treatments as required. Any appropriate method is adopted for such surface treatment depending on purposes. Examples thereof include a low-pressure plasma treatment, an ultraviolet irradiation treatment, a corona treatment, a flame treatment, and acid and alkali treatments. In one embodiment, the surface of the transparent base material is hydrophilized by subjecting the transparent base material to a surface treatment. When the transparent base material is hydrophilized, a transparent conductive film excellent in adhesiveness between the transparent base material and the intermediate layer can be obtained.

E-2. λ/4 Plate

In another embodiment, a λ/4 plate is used as the transparent base material. The λ/4 plate has an in-plane retardation Re of preferably from 95 nm to 180 nm, more preferably from 110 nm to 160 nm.

The thickness of the λ/4 plate is preferably from 5 μm to 80 μm, more preferably from 15 μm to 60 μm, still more preferably from 25 μm to 45 μm.

The λ/4 plate is preferably a stretched film of a polymer film. Specifically, the λ/4 plate is obtained by appropriately selecting the kind of a polymer and a stretching treatment therefor (e.g., a stretching method, a stretching temperature, a stretching ratio, and a stretching direction).

Any appropriate resin is used as the resin for forming the polymer film. A specific example thereof is a resin constituting a positive birefringent film, such as a cycloolefin-based resin, e.g., polynorbornene, a polycarbonate-based resin, a cellulose-based resin, a polyvinyl alcohol-based resin, or a polysulfone-based resin. Of those, polynorbornene or a polycarbonate-based resin is preferred.

The polynorbornene described in the section E-1 can be used as the polynorbornene.

An aromatic polycarbonate is preferably used as the polycarbonate-based resin for forming the λ/4 plate. The aromatic polycarbonate can be typically obtained through a reaction of a carbonate precursor and an aromatic dihydric phenol compound. Specific examples of the carbonate precursor include phosgene, a bischloroformate of a dihydric phenol, diphenyl carbonate, di-p-tolyl carbonate, phenyl-p-tolyl carbonate, di-p-chlorophenyl carbonate, and dinaphthyl carbonate. Of those, phosgene or diphenyl carbonate is preferred. Specific examples of the aromatic dihydric phenol compound include 2,2-bis(4-hydroxyphenyl)propane, 2,2-bis(4-hydroxy-3,5-dimethylphenyl)propane, bis(4-hydroxyphenyl)methane, 1,1-bis(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane, and 1,1-bis(4-hydroxyphenyl)-3,3,5-trimethylcyclohexane. They may be used alone or in combination. Of those, 2,2-bis(4-hydroxyphenyl)propane, 1,1-bis(4-hydroxyphenyl)cyclohexane, or 1,1-bis(4-hydroxyphenyl)-3,3,5-trimethylcyclohexane is preferably used. It is particularly preferred to use 2,2-bis(4-hydroxyphenyl)propane and 1,1-bis(4-hydroxyphenyl)-3,3,5-trimethylcyclohexane in combination.

A method of stretching the polymer film forming the λ/4 plate is, for example, lateral uniaxial stretching, fixed-end biaxial stretching, or sequential biaxial stretching. The fixed-end biaxial stretching is specifically, for example, a method involving stretching the polymer film in its short direction (lateral direction) while causing the film to run in its lengthwise direction. The method can be apparently the lateral uniaxial stretching. In addition, oblique stretching can be adopted. The adoption of the oblique stretching can provide a stretched film having an elongate shape and having an alignment axis (slow axis) at a predetermined angle relative to its widthwise direction.

The glass transition temperature of the material constituting the λ/4 plate is preferably from 100° C. to 200° C., more preferably from 110° C. to 180° C., particularly preferably from 110° C. to 160° C. When the glass transition temperature falls within such range, a transparent conductive film excellent in heat resistance can be obtained.

The λ/4 plate may also further contain any appropriate additive. In addition, the λ/4 plate may be subjected to various surface treatments as required. Specific examples of the additive and the surface treatments are as described in the section E-1.

F. Other Layer

The transparent conductive film may include any appropriate other layer as required. Examples of the other layer include a hard coat layer, an antistatic layer, an antiglare layer, an antireflection layer, and a color filter layer.

The hard coat layer has a function of imparting chemical resistance, scratch resistance, and surface smoothness to the transparent base material.

Any appropriate material may be adopted as a material constituting the hard coat layer. Examples of the material constituting the hard coat layer include an epoxy-based resin, an acrylic resin, and a silicone-based resin, and a mixture thereof. Of those, an epoxy-based resin excellent in heat resistance is preferred. The hard coat layer can be obtained by curing any such resin with heat or an active energy ray.

G. Method of producing Transparent Conductive Film

The transparent conductive film of the present invention can be produced by, for example, forming the intermediate layer on the transparent base material, then applying a dispersion liquid of the conductive filler onto the intermediate layer, and then applying a resin solution for forming a resin layer onto the resultant. Description is given below by taking a production method when a metal nanowire is used as the conductive filler as an example.

The transparent base material described in the section E can be used as the transparent base material.

Any appropriate method may be adopted as a method of forming the intermediate layer. When the intermediate layer includes an organic material, the intermediate layer can be formed by, for example, applying an application liquid containing any appropriate resin onto the transparent base material. In addition, when the intermediate layer includes an inorganic material, the intermediate layer can be formed by, for example, a vacuum deposition method, a sputtering method, or an ion plating method.

The metal nanowire dispersion liquid can be obtained by, for example, dispersing the metal nanowire described in the section C in any appropriate solvent. Examples of the solvent include water, an alcohol-based solvent, a ketone-based solvent, an ether-based solvent, a hydrocarbon-based solvent, and an aromatic solvent. Water is preferably used from the viewpoint of a reduction in environmental load.

The dispersion concentration of the metal nanowire in the metal nanowire dispersion liquid is preferably from 0.1 wt % to 1 wt %. When the dispersion concentration falls within such range, a conductive film excellent in conductivity and light transparency can be formed.

The metal nanowire dispersion liquid may further contain any appropriate additive depending on purposes. Examples of the additive include an anticorrosive material for preventing the corrosion of the metal nanowire and a surfactant for preventing the agglomeration of the metal nanowire. The kinds, number, and amount of additives to be used can be appropriately set depending on purposes. In addition, the metal nanowire dispersion liquid may contain any appropriate binder resin as required as long as the effects of the present invention are obtained.

The metal nanowire dispersion liquid can be applied by any appropriate method, such as slot die coating. Any appropriate drying method (such as natural drying, blast drying, or heat drying) may be adopted as a method of drying the applied layer. In the case of, for example, the heat drying, a drying temperature is typically from 100° C. to 200° C. and a drying time is typically from 1 minute to 10 minutes.

After the metal nanowire dispersion liquid has been applied, the resin solution for forming a resin layer is applied to form the resin layer. The resin solution contains the resin described in the section B or a precursor of the resin (a monomer constituting the resin).

The resin solution may contain a solvent. Examples of the solvent contained in the resin solution include an alcohol-based solvent, a ketone-based solvent, tetrahydrofuran, a hydrocarbon-based solvent, and an aromatic solvent. The solvent is preferably volatile. The boiling point of the solvent is preferably 200° C. or less, more preferably 150° C. or less, still more preferably 100° C. or less.

The resin solution may further contain any appropriate additive depending on purposes. Examples of the additive include a cross-linking agent, a polymerization initiator, a stabilizer, a surfactant, and a corrosion inhibitor.

When a conductive pattern is formed on the conductive film, the conductive pattern is formed by any appropriate method. The conductive pattern can be formed by, for example, removing, after the formation of the resin layer, the conductive filler (e.g., a metal nanowire) according to a wet etching method involving using a mask of a predetermined pattern to form, in the resin layer, a conductive region (region where the conductive filler is present) formed in a predetermined pattern and an insulating region (region where the conductive filler is not present). Any appropriate method may be employed as the wet etching method. As a specific operation of the wet etching method, for example, there is given an operation disclosed in US 2011/0253668 A. This publication is incorporated herein by reference.

Another method of forming the conductive pattern is, for example, a method involving selectively applying the metal nanowire dispersion liquid according to a screen printing method.

Still another method of forming the conductive pattern is, for example, the following method: after a transparent conductive film has been obtained so that the conductive filler may be present over the entirety of its resin layer, the insulating region serving as a region insulated from the conductive region is formed by breaking the conductive filler with a YAG laser or the like.

H. Application

The transparent conductive film may be used in electronic equipment, such as a display element. More specifically, the transparent conductive film can be used as, for example, an electrode to be used in a touch sensor, a touch panel, or the like, or an electromagnetic wave shield for cutting off an electromagnetic wave that causes malfunctioning of electronic equipment.

### EXAMPLES

### Example 1

### Electric Field Intensity in State where Conductive Filler is not Present

With regard to a film including a transparent base material, an intermediate layer, and a resin layer, and being free of any conductive filler, the electric field intensity of light in the resin layer and the electric field intensity of the light in the transparent base material were determined by a simulation involving using “Microwave Studio 2013” manufactured by CST. It should be noted that the electric field intensities were determined with a frequency domain solver. The results are shown in Table 1.

The thicknesses and average refractive indices of the transparent base material, the intermediate layer, and the resin layer are as described below. On the simulation, the following air layer was set outside the resin layer for reflecting the fact that the resin layer was on the outermost side.

Transparent base material: thickness d=500 nm/average refractive index n=1.5
Intermediate layer: thickness d=20 nm/average refractive index n=1.7
Resin layer: thickness d=100 nm/average refractive index n=1.3
Air layer: thickness d=500 nm/average refractive index n=1.0

Light having a wavelength of 550 nm was caused to enter the film from a resin layer side.

A position distant from an interface between the intermediate layer and the resin layer by 25 nm was defined as the point at which the electric field intensity in the resin layer was measured.

A position distant from an interface between the intermediate layer and the transparent base material by 500 nm was defined as the point at which the electric field intensity in the transparent base material was measured.

(Scattering Cross Section Resulting from Conductive Filler (Silver Nanowire))

In a setting in which a metal nanowire (silver nanowire) was arranged in the resin layer of the film, a scattering cross section representing a light scattering intensity by the silver nanowire was determined with a time domain solver by a simulation involving using “Microwave Studio 2013” manufactured by CST. The result is shown in Table 1.

One silver nanowire having a diameter of 50 nm and an infinite length was arranged in the resin layer. In addition, the silver nanowire was arranged so that the center of a radial direction cross section thereof corresponded to the position distant from the interface between the intermediate layer and the resin layer by 25 nm. It should be noted that with regard to the silver nanowire, a setting in which the one silver nanowire having an infinite length is arranged is adopted as a setting for an evaluation, and is different from an actual embodiment.

Light having a wavelength of 550 nm was caused to enter as incident light from the resin layer side as in the section “Electric Field Intensity in State where Conductive Filler is not present.”

The scattering cross section was determined by using an electric field parallel to the lengthwise direction of the silver nanowire and an electric field perpendicular thereto with the traveling direction of the light (direction vertical to the resin layer) defined as an axis.

Upon determination of the scattering cross section, a relative dielectric constant s (co) of silver was calculated by using Drude's equation represented by the following equation (1).

∈(ω)=∈_{∞}−ωₚ²/{ω(ω+iδ)} (1)

∈_{∞}=5.266, ωₚ=9.6 eV, and δ=0.054, which were described in Applied Physics Letters, Volume 80, Number 10, 1826-1828 (2002), were used as the respective parameters.

### Examples 2 to 8 and Comparative Example 1

A simulation was performed by the same method as that of Example 1 except that the average refractive indices and thicknesses of the respective layers were set as shown in Table 1. The results are shown in Table 1.

TABLE 1

| | Transparent base | | | | | | | Electric field | Electric field | Scattering |
|---|---|---|---|---|---|---|---|---|---|---|
| | material | | Intermediate layer | | Resin layer | | Electric field | intensity in | intensity in resin | cross |
| | Refrac- | Thick- | Refrac- | Thick- | Refrac- | Thick- | intensity in | transparent | layer/electric field | section by |
| | tive | ness | tive | ness | tive | ness | resin layer | base material | intensity in transparent | silver |
| | index n | d (nm) | index | d (nm) | index | d (nm) | (×10⁸ V/m) | (×10⁸ V/m) | base material × 100 | nanowire |
| Example 1 | 1.5 | 500 | 1.7 | 20 | 1.3 | 100 | 4.88 | 5.00 | 97.6 | 1,948 |
| Example 2 | 1.5 | 500 | 1.7 | 20 | 1.4 | 100 | 4.81 | 4.97 | 96.8 | 1,838 |
| Example 3 | 1.5 | 500 | 1.7 | 20 | 1.5 | 100 | 4.72 | 4.93 | 95.7 | 1,760 |
| Example 4 | 1.5 | 500 | 1.9 | 20 | 1.5 | 100 | 4.50 | 4.96 | 90.7 | 1,753 |
| Example 5 | 1.5 | 500 | 1.9 | 20 | 1.7 | 100 | 4.33 | 4.88 | 88.7 | 1,766 |
| Example 6 | 1.5 | 500 | 1.7 | 50 | 1.5 | 100 | 4.51 | 4.98 | 90.6 | 1,727 |
| Example 7 | 1.5 | 500 | 1.9 | 50 | 1.5 | 100 | 4.16 | 5.01 | 83.0 | 1,711 |
| Example 8 | 1.5 | 500 | 1.9 | 50 | 1.7 | 100 | 4.04 | 4.99 | 81.0 | 1,737 |
| Comparative | 1.5 | 500 | 1.3 | 20 | 1.3 | 100 | 5.30 | 5.00 | 106.0 | 1,973 |
| Example 1 | | | | | | | | | | |

As is apparent from Table 1, when a conductive region is formed by introducing a conductive filler into a resin layer capable of transmitting light whose electric field intensity has been adjusted to fall within the range, the scattering of the light by the conductive filler can be suppressed.

### REFERENCE SIGNS LIST

1 conductive filler
10 resin layer
11 conductive region
12 insulating region
20 intermediate layer
30 transparent base material
100 transparent conductive film

1. A transparent conductive film, comprising, in this order:
a resin layer;
an intermediate layer; and
a transparent base material, wherein:
the transparent conductive film contains a conductive filler present in the resin layer;
the transparent base material has an average refractive index of less than 1.6; and
when light is caused to enter the transparent conductive film from a resin layer side, an electric field intensity of the light in the resin layer is less than 100% relative to an electric field intensity of the light in the transparent base material.

2. The transparent conductive film according to claim 1, wherein:
the intermediate layer has an average refractive index of 1.5 or more; and
the intermediate layer has a thickness of 200 nm or less.

3. The transparent conductive film according to claim 1, wherein an average refractive index of the resin layer is lower than an average refractive index of the intermediate layer.

4. The transparent conductive film according to claim 1, wherein the conductive filler comprises a metal nanowire.

5. The transparent conductive film according to claim 4, wherein the metal nanowire comprises a silver nanowire.

6. A touch sensor, comprising the transparent conductive film of any one of claim 1.
